(19) United States
(12) Patent Application Publication
(10) Pub. No.: US 2003/0195926 A1
(43) Pub. Date: Oct. 16, 2003

(54) Image forming system

(76) Inventor: Ken Miyazaki, Tokyo (JP)

Correspondence Address: CANTOR COLBURN LLP, 55 Griffin Road South, Bloomfield, CT, 06002, US

(21) Appl. No.: 10/411,793

(22) Filed: Apr. 11, 2003

(30) Foreign Application Priority Data
Apr. 15, 2002 (JP) 111924/2002
Aug. 28, 2002 (JP) 248552/2002

(51) Int. Cl. G06F 15/16

(52) U.S. Cl. 709/203

(57) ABSTRACT

This invention provides an image forming system in which one or a plurality of information processing apparatuses and one or a plurality of image forming apparatuses are connected to each other through a network, in which a first information processing apparatus includes a model information inquiry section which inquires about model information of each apparatus connected to the network, an image processing section which executes for the image data, image processing based on the model information, and a data distribution section which distributes job data based on the model information and the processed image data that has undergone the image processing on the basis of the model information to each of the apparatuses connected to each other through the network, and each of the image forming apparatuses includes a first data reception section which receives the job data based on the processed image data and model information from the data distribution section, and an image forming section which forms an image on a transfer material on the basis of the processed image data.

### BACKGROUND OF THE INVENTION

1. Field of the Invention

The present invention relates to an image forming system and, more particularly, to an image forming system formed by connecting at least one or a plurality of image forming apparatuses and at least one or a plurality of information processing apparatuses are connected through a network.

2. Description of the Prior Art

Conventionally, an image forming apparatus such as a digital copying machine having an image reading section which reads an image from an original with the image recorded thereon and outputs it as image data and an image forming section which forms an image on a paper sheet or the like on the basis of the image data is known well.

In such an image forming apparatus, for example, simple image processing such as trimming can be executed for the image data read by the image reading section, and the image forming section can form an image on the basis of the image data after image processing.

An image forming system used in a network environment has conventionally been provided.

This image forming system is formed by connecting, through a network, e.g., an image forming apparatus such as a digital copying machine to an information processing apparatus such as a personal computer or workstation which instructs the image forming apparatus to scan (read) or print an image. A plurality of image forming apparatuses or a plurality of information processing apparatuses may be connected to a network.

Such an image forming system is known to be used in a scanner mode wherein, e.g., the information processing apparatus instructs the image forming apparatus to read an image, and the image read by the image forming apparatus is transferred to the information processing apparatus.

In the conventional image forming system, for example, the image data of an image read by the image forming apparatus in the scanner mode is transferred to the information processing apparatus. Upon receiving the image data, the information processing apparatus directly stores the image data in, e.g., a hard disk as an image file or transfers the image data to the image forming apparatus to form an image, as needed. A so-called Internet FAX in which an image is transmitted using an email function has also conventionally been known.

Japanese Unexamined Patent Publication No. 2001-333237 discloses an image forming system which allows a user to select, when image data should be subjected various kinds of image processing, whether the image processing is to be executed by the image forming apparatus, or the image data is to be transferred to the information processing apparatus through the network and subjected to image processing by the information processing apparatus.

The conventional image forming system causes another apparatus connected through the network to execute image processing, thereby distributing image processing.

However, when an image is transmitted using the email function, as described above, the capacity is limited by the mail server, and a large quantity of data cannot be transmitted.

In the above-described conventional image forming system disclosed in Japanese Unexamined Patent Publication No. 2001-333237, a means for transferring image data from the image forming apparatus to the information processing apparatus is arranged, and image processing is performed by the information processing apparatus at the transfer destination. However, this prior art discloses neither data consistency in the entire network system nor a user interface.

Now, it is explained what the user interface is.

Heretofore, in the image forming system in which plural apparatus of various kinds are connected to one another through a network, image processing conducted by a PC server is performed without taking an image output characteristics of an image forming apparatus into consideration.

For example, even if such an image processing as changing a resolution to 600 dpi is applied to an image forming apparatus having an image output characteristics of the resolution of 400 dpi, which is a destination of output, an image having the size of 1.5 times bigger is outputted at the image forming apparatus.

In addition, even if a sepia conversion processing for converting a monochrome image into a sepia image is conducted for an image forming apparatus having an image output characteristics of only a monochrome image, it is impossible for the image forming apparatus to form a sepia image.

Further, even when such a processing as changing a format of a image data is conducted, it becomes impossible to form any image if an image forming apparatus which is a destination of the data output does not corresponds to the format.

As a result, there is no such a guarantee as an image processing applicable to the image forming apparatus concerned is just outputted.

However, if a PC server has an information of image output characteristics in each of image forming apparatuses connected to the PC server previously, it becomes possible to provide each image forming apparatus with a suitable image processing applicable thereto through the fact that the PC server uses model information of each image forming apparatus.

As is clear from the foregoing explanation, it is the user interface that, through the fact that the PC server uses model information of each of image forming apparatuses connected to the PC server, a certain processing function applicable to each image forming apparatus is provided for its operating section.

It is another problem that a user who is going to make desired copies using a copying machine serving as an image forming apparatus may be confused if image formation suddenly starts in that copying machine in accordance with an instruction from another user who is using another apparatus connected to the copying machine through a network.

In the conventional image forming system, if a number of kinds of image processing are provided to a user, user operation of selecting and instructing desired image processing is cumbersome and inconvenient.

When a plurality of image forming apparatuses are connected to the network, some types of image processing may be coped with by a certain image forming apparatus but not by another image forming apparatus. For example, an image forming apparatus that can process only monochrome images cannot cope with image processing for color images. It is insignificant for such an image forming apparatus to receive image data that has undergone image processing for color images in the information processing apparatus.

Furthermore, the conventional image forming system cannot discriminate between processing with which the entire network of the image forming system can cope and processing with which the individual image forming apparatuses can cope. For this reason, the user may be confused in operation because he/she cannot know image processing that can be coped with by the image forming apparatus currently under operation.

In the conventional image forming system, to set the image processing function in each apparatus connected to the network, the user must do it in each apparatus. If the apparatuses are installed away from each other, the user must go round for the apparatuses, resulting in very cumbersome work.

The conventional image forming system takes no account of the image processing efficiency, i.e., shortening the time until the end of distributed image processing. For this reason, if image processing is simply distributed, the time until the end of processing may sometimes become longer than non-distributed image processing.

In the image forming system, it is not preferable from the viewpoint of operability improvement to make the user aware of the function provided by each apparatus on the network in detail. For this reason, the user who uses the function of another apparatus connected to the network may unnoticeably distribute image data to an unexpected apparatus. In addition, the user may leak highly confidential data to an unexpected person by operation errors.

### SUMMARY OF THE INVENTION

The present invention has been made in consideration of the above problems of the conventional image forming system, and has as its first object to provide an image forming system formed from an image forming apparatus and information processing apparatus connected to a network, which can exchange data independently of the model of the image forming apparatus connected to the system and process a large capacity of data with an increased convenience for a user.

It is the second object of the present invention to provide an image forming system formed from a plurality of image forming apparatuses and information processing apparatuses connected to a network, which provides, to a user, information of image processing that can be coped with by each of the plurality of image forming apparatuses and has an improved operability and maintenance property.

It is the third object of the present invention to provide an image forming system formed from a plurality of image forming apparatuses and information processing apparatuses connected to a network, which can efficiently end image processing when image processing desired by a user is to be executed for image data in image formation.

It is the fourth object of the present invention to provide an image forming system formed from a plurality of apparatuses such as image forming apparatuses connected to a network, which is capable of security management of data.

In order to achieve the above objects, the present invention has the following main aspect.

According to the first main aspect, there is provided an image forming system in which at least one or a plurality of information processing apparatuses which execute image processing for image data and at least one or a plurality of image forming apparatuses which form an image on a transfer material (paper sheet) on the basis of the image data that has undergone the desired image processing are connected to each other through a network, wherein

a first information processing apparatus comprises

model information inquiry means for inquiring about model information of each apparatus connected to the network,

image processing means for executing, for the image data, image processing based on the model information, and

data distribution means for distributing job data based on the model information and the processed image data that has undergone the image processing on the basis of the model information to each of the apparatuses connected to each other through the network, and

each of the image forming apparatuses comprises

first data reception means for receiving the job data based on the processed image data and model information from the data distribution means, and

image forming means for forming the image on the transfer material on the basis of the processed image data.

The image forming system according to the above main aspect has the following sub-aspects.

According to the first sub-aspect, the image processing executed by the image processing means on the basis of the model information is processing of changing a data format of the image data.

According to the second sub-aspect, the image processing executed by the image processing means on the basis of the model information is processing of changing a resolution or number of gray levels of the image data.

According to the third sub-aspect, the image processing executed by the image processing means on the basis of the model information is processing of converting color image data into monochrome image data and vice versa.

According to the fourth sub-aspect, the first information processing apparatus further comprises distribution destination designation means for allowing a user to designate a designation of distribution of the processed image data by the data distribution means, the distribution destination designation means having group forming means for putting other apparatuses connected to the network into a group, and

when the user is to designate the distribution destination, the apparatuses put into the group by the group forming means can be designated at a time.

According to the fifth sub-aspect, when the data distribution means is to distribute the image data to the plurality of image forming apparatuses which execute tandem output, a data amount to be allotted to each of the plurality of image forming apparatuses which execute tandem output is determined on the basis of the model information.

According to the sixth sub-aspect, each image forming apparatus further comprises banner image forming means for forming a banner image representing a processing result of image formation when the image forming means is to form the image on the basis of the processed image data received by the first data reception means.

According to the seventh sub-aspect, the banner image formed by the banner image forming means represents information about a distribution source of the image data.

According to the eighth sub-aspect, the first information processing apparatus further comprises transmission destination specifying information transmission means for transmitting, to an apparatus at a distribution destination, transmission destination specifying information formed from a predetermined character or symbol corresponding to an address of the apparatus at the transmission destination when the data distribution means is to distribute the processed image data.

According to the ninth sub-aspect, the data distribution means distributes the processed image data and job data to each of the apparatuses connected to each other through the network at a predetermined designated time.

According to the 10th sub-aspect, each of the image forming apparatuses further comprises

image data transmission means for transmitting information about desired image processing to be executed for the image data to the first information processing apparatus together with the image data,

list request transmission means for transmitting model information of the image forming apparatus to the first information processing apparatus together with a request of an image processing program list, and

list display means for displaying a list of executable image processing programs on the basis of the image processing program list received from the information processing apparatus as a reply to the request transmitted by the list request transmission means, and

the first information processing apparatus further comprises

list generation means for generating the image processing program list on the basis of the model information received from each of the image forming apparatuses, and

list transmission means for transmitting the image processing program list generated by the list generation means to the image forming apparatus that has requested the image processing program list.

According to the 11th sub-aspect, the processed image data transmission means comprises image processing use frequency recording means for recording a use frequency of image processing of each type requested for the image data received from the image forming apparatus,

the list generation means generates the program list on the basis of the use frequency recorded by the image processing use frequency recording means, and

the list display means determines an order of display of image processing operations in the list of the executable image processing programs on the basis of the program list generated on the basis of the use frequency.

According to the 12th sub-aspect, there is provided an image forming system further comprising a universal apparatus which is connected to the image forming apparatuses and information processing apparatuses through the network and has a universal display section, a universal operation section, and remote setting means for executing setting related to image processing and job processing on the basis of the model information of the image forming apparatuses and information processing apparatuses.

As is apparent from the above aspects, according to the present invention, each apparatus connected to the system can exhibit a function corresponding to that apparatus in accordance with the model of the apparatus.

According to the present invention, in inquiring about the model information of the transmission destination, the manufacturing number of the apparatus can be used as the model information. Hence, processing (e.g., staple function or the like) unique to the apparatus can be performed.

According to the present invention, processing that copes with various data formats (e.g., RAW, BMP, TIFF, TXT, TEX, HTML, and PDF) can be performed in accordance with the apparatus at the transmission destination.

According to the present invention, since the resolution or number of gray levels of an image can be changed in accordance with the apparatus at the transmission destination, the data dependence on the model can be eliminated.

According to the present invention, since a color image and monochrome image can be converted to each other in accordance with the apparatus at the transmission destination, compatibility between a color machine and a monochrome machine can be ensured.

According to the present invention, the server executes various functions and processing operations. Hence, when function expansion or upgrading is necessary, it needs to be executed only in the server.

According to the present invention, when IP addresses and DNS names are registered and put into groups in advance, they need not be input and set every time.

According to the present invention, since the use can be notified of the ON/OFF state of each copying machine or PC that is currently present on the network, the convenience for the user can be increased.

According to the present invention, since user authentication can be executed, usable functions can be limited for each user.

According to the present invention, since users can be put into groups, and usable functions can be limited for each group, setting needs to be performed only once, and its cumbersomeness can be eliminated.

According to the present invention, the server has a spool function. Hence, even when the apparatus at the output destination is outputting another data, processing can be suspended until the apparatus ends the current operation. Output can be performed when the apparatus becomes free.

According to the present invention, since the printout time can be designated, output can be performed at an arbitrary time.

According to the present invention, tandem output can be executed as needed.

According to the present invention, the FCOT of each of a plurality of copying machines can be grasped on the basis of the model information of each output destination. Since the data amount to be allotted to each copying machine in tandem processing can be changed on the basis of the FCOT, efficient tandem output can be implemented.

According to the present invention, since the tandem destinations can be put into groups, the tandem destinations need not be input and set every time.

According to the present invention, since copying machines locally connected are automatically selected as tandem destinations on the basis of IP addresses, tandem operation with a copying machine at a remote site can be prevented.

According to the present invention, since a cover can be output as a banner function at the output destination, the output request source-can clearly be known.

According to the present invention, since thumbnails of output matter can be printed, the data contents can be grasped at a glance.

According to the present invention, since the distribution result can be transmitted as email, the user can easily know whether the processing has successfully been done or failed.

According to the present invention, since a fixed character or symbol can be added to an image for each IP address of the transmission destination, the reliability of distributed matter can be increased.

According to the present invention, when image data to be transmitted is encrypted, any leakage of confidential information can be prevented.

According to the present invention, since the image forming apparatus displays the names of available image processing operations for the user on the basis of the image processing program list generated by the information processing apparatus on the basis of the model information of the image forming apparatus, the user can be prevented from selecting unavailable image processing, so he/she is not confused in operation.

According to the present invention, since the names of image processing operations that are frequently used by the user can be displayed at positions convenient for the user, a convenient operation window can be provided. In addition, since unselectable buttons are grayed out, the user can be prevented from being confused in operation.

According to the present invention, since the user can execute remote control to set the image processing function or manage various states in each apparatus connected to the network only by operating the universal apparatus, he/she need not go round for the installation locations.

According to the present invention, since the server can grasp the processing capability of each client server and distribute image processing in an amount corresponding to each capability, fastest image processing in the entire image forming system can be implemented.

According to the present invention, since security is set for each processing executed in the image forming system, and the communicable range in the network is defined in accordance with the security, highly secure network processing can be performed.

According to the present invention, the user can select whether the network is to be used. Hence, security can be managed by preventing, by user's choice, any leakage of data that is recognized by the user himself/herself as confidential data.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the schematic overall arrangement of an image forming system according to the first embodiment of the present invention;

FIG. 2 is a block diagram showing the schematic arrangement of a digital copying machine 5 shown in FIG. 1;

FIG. 3 is a block diagram showing the schematic arrangement of a server 4 shown in FIG. 1;

FIG. 4 is a block diagram showing the schematic arrangement of a PC 1 shown in FIG. 1;

FIG. 5 is a flow chart showing the operation of the image forming system shown in FIG. 1;

FIG. 6 is a flow chart showing account processing indicated by step (A-3) in FIG. 5;

FIG. 7 is a flow chart showing processing in the server, which is indicated by step (A-6) in FIG. 5;

FIG. 8 is a flow chart showing processing of outputting a job to a designed output destination, which is indicated by step (A-7) in FIG. 5;

FIG. 9 is a view showing the operation window of one of the plurality of digital copying machines shown in FIG. 1;

FIG. 10 is a block diagram showing the schematic overall arrangement of an image forming system according to the third embodiment of the present invention;

FIG. 11 is a view showing the flow of data in the image forming system shown in FIG. 10;

FIG. 12 is a flow chart showing the operation of the image forming system shown in FIG. 10;

FIG. 13 is a table showing an example of security level in an image forming system according to the fourth embodiment of the present invention;

FIG. 14 is a block diagram showing the arrangement of main part of a digital copying machine used in an image forming system according to the fifth embodiment of the present invention;

FIGS. 15-1 to 15-3 are flow charts showing processing when a digital copying machine shown in FIG. 14 transmits a stamp image output instruction to another digital copying machine; and

FIG. 16 is a flow chart showing processing on the side of the digital copying machine that has received the stamp image output instruction.

### DETAILED DESCRIPTION OF THE PREFERRED EMBODIMENTS

Preferred embodiments of the present invention will be described below with reference to the accompanying drawings.

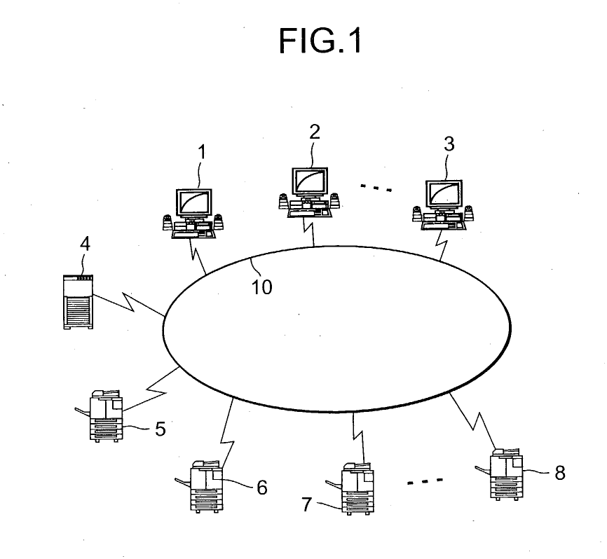

The schematic overall arrangement of an image forming system according to the first embodiment of the present invention will be described with reference to FIG. 1.

In the first embodiment, an electrophotographic digital copying machine will be exemplified as an image forming apparatus, and a PC (Personal Computer) will be exemplified as an information processing apparatus. In the following description, one of a plurality of PCs, which serves as a server in a network system, will be referred to as a server.

As shown in FIG. 1, in the image forming system according to the first embodiment, PCs 1 to 3, a server 4, and digital copying machines 5 to 8 are connected to a network 10.

Each of the digital copying machines 5 to 8 can independently read (scan) an original and form (print) an image. In addition, when they are connected to the network 10, an image read by, e.g., the digital copying machine 5 can be transferred to the digital copying machine 6 and then subjected to image formation by the digital copying machine 6, and vice versa. That is, an image read by one of the digital copying machines 5 to 8 can be transferred to another apparatus through the network 10. Alternatively, one of the digital copying machines 5 to 8 can receive an image from another apparatus and form the image.

In the first embodiment, the server 4 is also connected to the network 10. The server 4 can execute predetermined image processing for image data received from the digital copying machines 5 to 8 and return the image data to the transmission source. Alternatively, the server 4 may execute predetermined image processing for image data received from, e.g., the digital copying machine 5 and transfer the image data to the digital copying machine 6 different from the transmission source. In addition, the server 4 transfers job data received from the PCs 1 to 3 to a predetermined one of the digital copying machines 5 to 8 and causes the digital copying machine to form (print) an image.

Image processing here includes all image processing operations to be executed for image data, such as luminance adjustment, color tone adjustment, gray level adjustment, image trimming, image sharpening/softening, and imposition.

A job is formed by combining image data and processing information, i.e., contents of processing to be executed in printing the image data (for example, specific pages to be printed for the specific number of copies, paper size, color/monochrome, ON/OFF of perforation, ON/OFF of stapling, ON/OFF of automatic folding after image formation, ON/OFF of assignment of a plurality of images to one paper sheet (N-in-1 or imposition)).

Referring to FIG. 1, the network 10 can be a network of any type, e.g., a LAN such as Ethernet (registered trademark) or token ring, or the Internet. An address (e.g., an IP address) on the network is set for each apparatus connected to the network 10. Each apparatus is identified by this address and can communicate with another apparatus connected to the network 10.

Referring to FIG. 1, a plurality of PCs, i.e., information processing apparatuses and a plurality of digital copying machines, i.e., image forming apparatuses are used. However, one information processing apparatus and a plurality of image forming apparatuses, or a plurality of information processing apparatuses and one image forming apparatus may be used, as a matter of course.

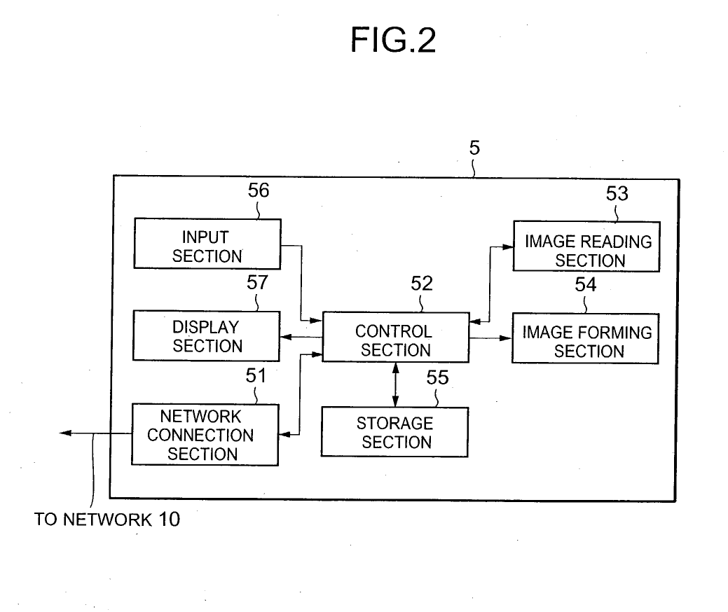

Subsequently, the arrangement of the digital copying machine 5 will be described with reference to FIG. 2. In the first embodiment, all the digital copying machines 5 to 8 shown in FIG. 1 have the same basic arrangement, and the digital copying machine 5 will representatively be explained.

The digital copying machine 5 has a network connection section 51 serving as an interface to the network 10 shown in FIG. 1, a control section 52 which controls the operation of the entire digital copying machine 5, an image reading section 53 which reads an image from an original, an image forming section 54 which forms an image on, e.g., a paper sheet, a storage section 55 which stores the job data of an image to be formed and parameters necessary for the operation of the digital copying machine 5, an input section 56 which inputs user operations and instructions for the digital copying machine 5, and a display section 57 which displays various kinds of information for the user. The input section 56 and display section 57 may be formed from an integrated operation window such as a touch panel.

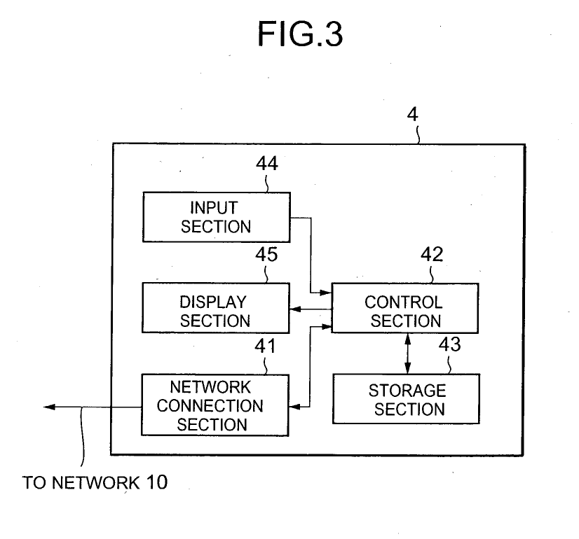

The arrangement of the server 4 will be described next with reference to FIG. 3.

The server 4 is constituted by a network connection section 41 serving as an interface to the network 10 shown in FIG. 1, a control section 42 which controls the operation of the entire server 4, a storage section 43 which stores a program to be executed by the control section 42, job data, and the like, an input section 44 which inputs user operations and instructions for the server 4, and a display section 45 which displays various kinds of information for the user.

The server 4 may have a function as a DNS (Domain Name System) server.

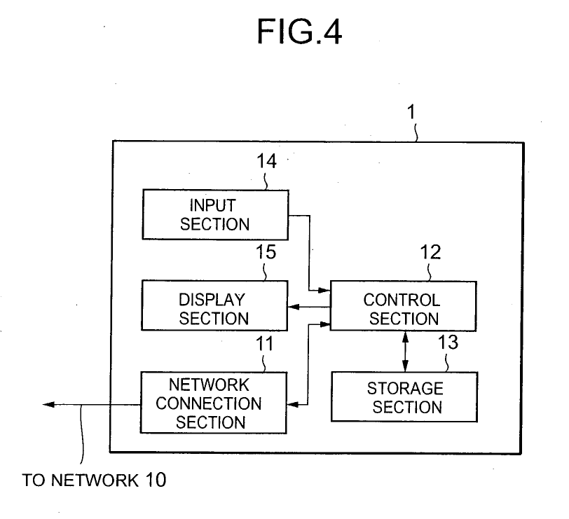

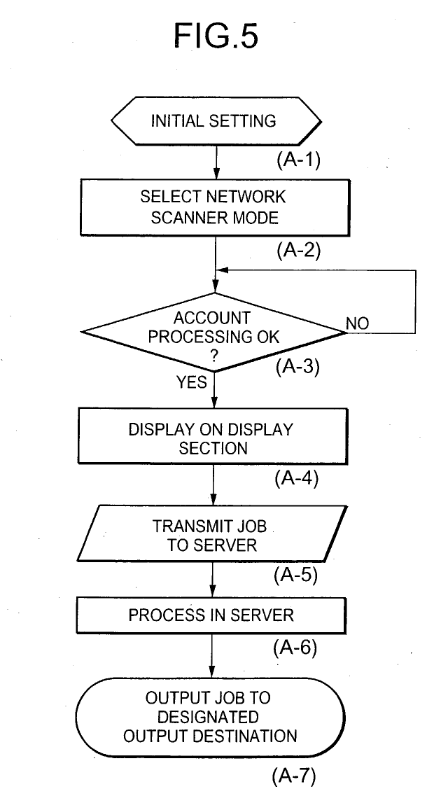

The arrangement of the PC 1 will be described now with reference to FIG. 4. In the first embodiment, all the PCs 1 to 3 shown in FIG. 1 have the same basic arrangement, and the PC 1 will representatively be explained.

The PC 1 is constituted by a network connection section 11 serving as an interface to the network 10 shown in FIG. 1, a control section 12 which controls the operation of the entire PC 1, a storage section 13 which stores a program to be executed by the control section 12, an image processing program to be used to process image data, job data, and the like, an input section 14 which inputs user operations and instructions for the client PC 1, and a display section 15 which displays various kinds of information for the user.

The operation of the first embodiment will be described next.

FIG. 5 is a flow chart showing the operation of the image forming system according to the first embodiment.

First, initial setting is performed in each apparatus connected to the network 10 (A-1).

For example, in the server 4, the user (the user is preferably limited to a super user such as a system administrator) can perform initial setting using the input section 44 and display section 45. At this time, the input section 44 and display section 45 preferably provide GUI (Graphical User Interface).

Examples of contents of initial setting in the server 4 are as follows.

1. The IP addresses/DNS names of output destination apparatuses are registered in, e.g., an address book (a list is formed).

2. Of the registered IP addresses/DNS names, predetermined IP addresses/DNS names are put into a group, and the group information is registered in the address book.

3. Digital copying machines which can perform tandem processing (a printing method of allotting a predetermined number of pages of a print output to each of the plurality of digital copying machines to shorten the time required for printing will be called “tandem” herein) are put into a group by looking up the address book (for example, it is not preferable from the viewpoint of convenience for the user who goes for printing results that the tandem processing be executed by copying machines installed away from each other, and it is not preferable either that copying machines which may catch third party's attention be put into a group to be used to output secret documents), and the tandem group information is registered in the address book.

4. User accounts (user names) are registered in a user list.

5. Prohibitions that define processing that is not permitted or unavailable for the users are set, and users under the same prohibition are put into a group and registered in a user group list.

6. In registering a new user, prohibition setting or user group assignment is performed for the user account and the user list is updated.

In each of the digital copying machines 5 to 8, the IP address of the server 4 is registered.

The user operates the operation section (input section 56 and display section 57) of, e.g., the digital copying machine 5 to select the network scanner mode (A-2) and cause the image reading section 53 to read an original image.

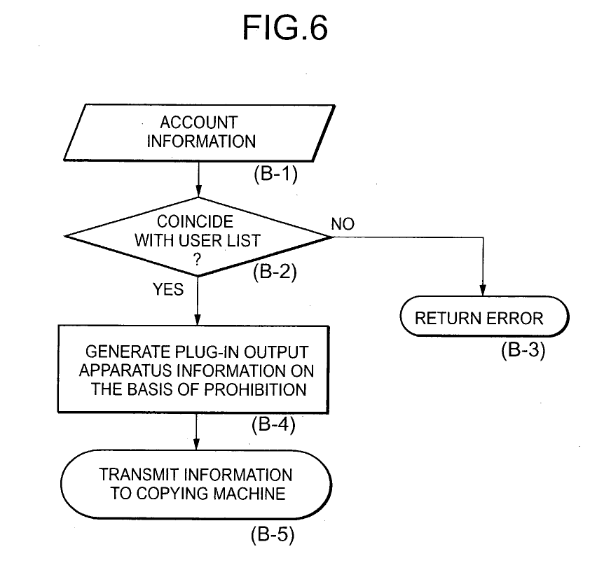

Then, the user inputs the user name, password, and the like to execute account processing (to be described later with reference to FIG. 6) (user authentication based on the user list stored in the storage section 43 of the server 4) (A-3). If YES in step (A-3), an operation guide for that user is displayed on the operation section of the digital copying machine 5 by, e.g. turning on display of functions usable by him/her and off display of unusable functions on the basis of the prohibition set for that user (the prohibition is stored in, e.g., the storage section 43 of the server 4) (A-4).

An example in which the user operates the operation section of the digital copying machine that reads the original has been described above. However, the present invention is not limited to this. For example, the user may operate the digital copying machine through the operation section (input section 14 ad display section 15) of the PC 1 by remote control. This also applies to the following description.

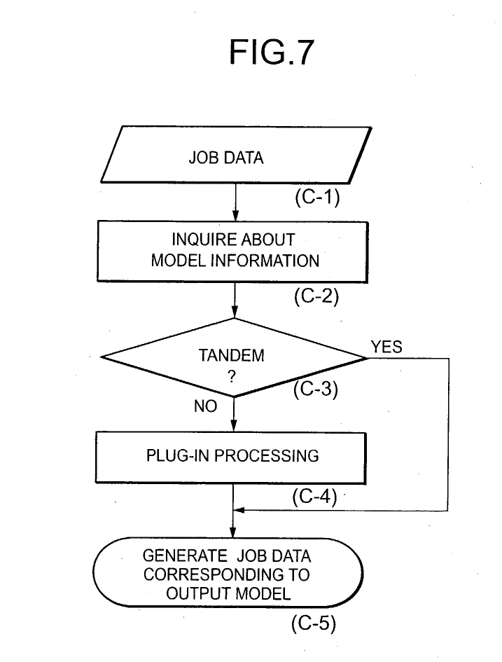

When the user refers to the display in step (A-4) and inputs desired processing, the read image data and processing information are transmitted to the server 4 as a job (A-5). The server 4 executes predetermined processing (A-6). The processing in the server 4 in step (A-6) will be described later with reference to FIG. 7.

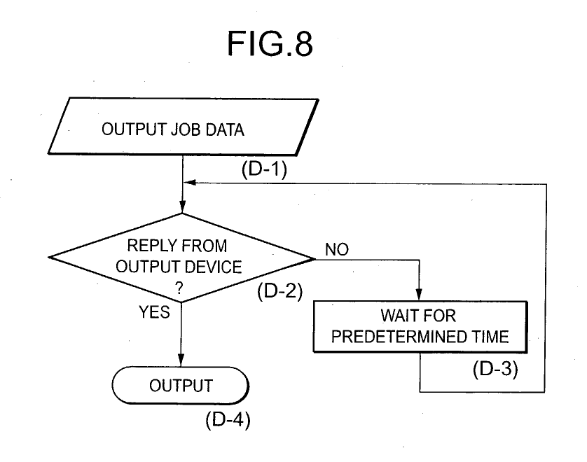

After that, job data is transmitted from the server 4 to an apparatus selected by the processing in the server 4 (A-7). At this time, since 1. “the IP addresses/DNS names of output destination apparatuses are registered in, e.g., an address book (a list is formed)”, and 2. “of the registered IP addresses/DNS names, predetermined IP addresses/DNS names are put into a group, and the group information is registered in the address book” in the above-described initial setting of the server 4, the output destination can easily be designated without inputting an IP address every time. Since each group can also be designated, the convenience increases. The processing in step (A-7) will be described later with reference to FIG. 8.

FIG. 6 is a flow chart showing account processing indicated by step (A-3) in FIG. 5.

The account processing is performed by the server 4 having the user list. However, a PC or digital copying machine may acquire the user list from the server 4 and execute the account processing.

When account information (user name, password, and the like) is input (B-1), it is determined whether the account information matches account information in the user list (B-2). If NO in step (B-2), a notification of account processing error is sent to the digital copying machine 5 (B-3) The digital copying machine 5 displays an error message on, e.g., the display section 57 to notify the user of it.

If YES in step (B-2), information about a plug-in (software that is arranged for each function and can load the function in an application by simple operation) to be used to execute processing usable by the user and an output apparatus (digital copying machine or PC) usable by the user is generated (B-4) and transmitted to the digital copying machine 5 as the request source (B-5). Display in step (A-4) is done on the basis of the information transmitted in step (B-5).

FIG. 7 is a flow chart showing processing in the server, which is indicated by step (A-6) in FIG. 5.

When job data is input to the server 4 (C-1), the server 4 inquires of each apparatus connected to the network 10 about model information (C-2). As model information for, e.g., a digital copying machine, the manufacturing number may be used. For a PC, the type of an extension in a file name representing a file format usable in that PC may be used.

With this inquiry about model information, the server 4 can know the power-ON/OFF states of each copying machine or PC connected to the network and also notify the user of it.

Subsequently, it is determined whether processing designated by the user is tandem processing (C-3). If YES in step (C-3), a plurality of digital copying machines to be used for tandem processing are determined by referring to the user designation, prohibition set for the user, and tandem group information in the address book. Job data is generated in correspondence with each model (C-5) Then, the flow advances to step (A-7).

If tandem processing is to be performed, and job data are to be assigned to the plurality of digital copying machines in charge of tandem output, for example, FCOT (First Copy Output Time: time after the start button is pressed until the first printed paper sheet is discharged) of each copying machine may be obtained on the basis of the information in step (C-2). The amount to be assigned to each copying machine may be determined on the basis of the FCOT.

In this embodiment, since 3. “digital copying machines which can perform tandem processing are put into a group by looking up the address book; and the tandem group information is registered in the address book” in the above-described initial setting of the server 4, the labor for inputting and setting the plurality of copying machines in charge of the tandem output every time can be omitted.

The server 4 may have an automatic tandem group forming function of automatically setting copying machines of local IP addresses to a tandem group. When copying machines are limited to local IP addresses, copying machines at remote sites or copying machines of third parties can automatically be excluded from the group.

In tandem processing, when one of the plurality of copying machines at the output destinations is executing another print job, the copying machine cannot immediately respond to the tandem request. In this case, tandem processing is insignificant. To cope with such a case, in the first embodiment, the server 4 can inquire each of the plurality of copying machine in the tandem group about the current operation situation and determine on the basis of it whether the tandem request is to be sent to each copying machine.

If NO in step (C-3), plug-in processing corresponding to the designated processing is performed (C-4). The output destination apparatus is determined by referring to the user designation, prohibition set for the user, and the like. Job data is generated in correspondence with the model of the apparatus (C-5). Then, the flow advances to step (A-7).

As a detailed example in generating job data in correspondence with the model of the output destination apparatus in step (C-5), the resolution or number of gray levels of the image data is converted. Alternatively, a color image is converted into a monochrome image, and vice versa.

FIG. 8 is a flow chart showing processing of outputting a job to the designed output destination, which is indicated by step (A-7) in FIG. 5.

In this processing by the server 4, the job data generated in step (C-5) is input (D-1). The server 4 inquires the designated apparatus at the job data output destination to confirm whether the apparatus is currently operating, and waits for a reply (D-2 and D-3). Upon receiving a reply, the server 4 outputs the job data to the apparatus (D-4).

The server 4 has a spool function of spooling the job data during waiting for the reply from the output destination apparatus. More specifically, the server 4 spools the job data, retries communication at a predetermined interval, and waits for a reply from the output destination apparatus. When the retry has failed a predetermined number of times, the communication retry interval may be changed (e.g., increased).

If no reply is received at all, predetermined processing, e.g., processing of notifying the user that the output destination apparatus does not reply may be executed.

When the user instructs execution of the job from the digital copying machine 5 or PC 1, the printout time may be designated. In this case, the server 4 preferably spools the job data until the designated time.

A digital copying machine which prints on the basis of the job data transmitted from the server 4 preferably prints, before printing the job data, a cover having information representing the details of printing, including as the name of the user who has requested the output and the apparatus that has sent the output request (so-called banner function). The cover may be formed in the server 4 and automatically printed by the digital copying machine. Alternatively, the cover may be formed and printed by the digital copying machine. This increases the convenience because even when a copying machine receives a plurality of requests, the request source of each printing result can clearly be known.

When a plurality of pages are to be printed by a digital copying machine which prints on the basis of job data transmitted from the server 4, a predetermined number of (N) images of the plurality of pages can be printed on one paper sheet (so-called N-in-1 printing) as thumbnails. The user can use the thumbnails as the indices of the series of printed images and grasp the document at a glance.

When printing in step (D-4) in FIG. 8 is ended, the server 4 preferably notifies the user of the end of printing or information representing the copying machine that has output the image data. This notification may be transmitted to the user's email address that is registered in advance, or displayed on the display section 57 of the digital copying machine 5 or the display section 15 of the PC 1 operated by the user.

The mail may be transmitted not only to the user but also to the system administrator. In addition, not only when job data distribution to the PC or printing by the copying machine is normally ended but also when an error has occurred, a notification representing the error is preferably transmitted together with the situation.

The IP address of each apparatus connected by the network 10 is registered in the server 4. A predetermined character or symbol may be registered in correspondence with each IP address. When a character or symbol corresponding to the transmission destination apparatus is transmitted together with the image data, the reliability of image distribution can be increased.

When image data is to be transmitted to each apparatus, the data is preferably encrypted and transmitted. For this encryption, for example, an encoding means for encoding image data in accordance with the user account (user name) and password may be arranged on the transmission source. At the transmission destination, a decoding means for requesting the user to input the user account and password and decoding the image data in accordance with the input user account and password may be arranged.

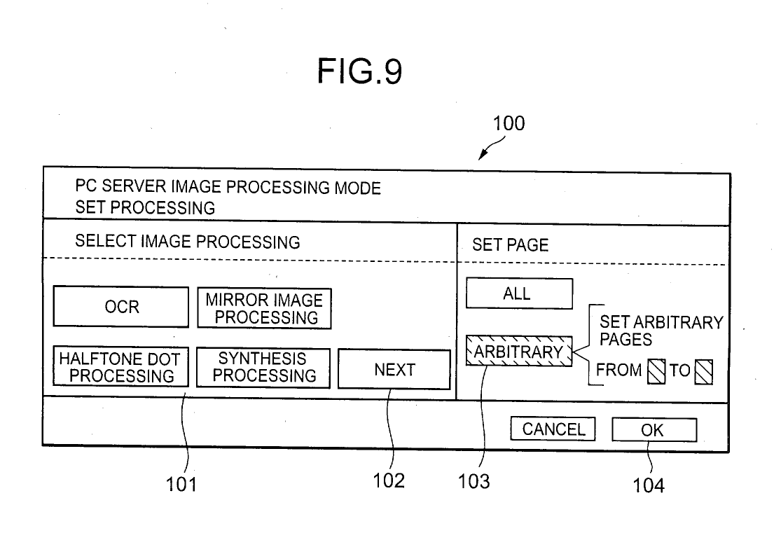

An image forming system according to the second embodiment of the present invention will be described next with reference to FIGS. 1 and 9.

One or all of PCs 1 to 3 shown in FIG. 1 can have a function as a universal apparatus. The universal apparatus has a universal display section 16 and universal operation section 17 and is designed to set the image processing function or manage various states, by remote control, in each digital copying machine connected to a network 10. Hence, the user can execute remote control to set the image processing function or manage various states in each apparatus connected to the network 10 only by operating the universal apparatus. The user need not go round for the installation locations of apparatuses.

The operation of the second embodiment will be described next.

Each of digital copying machines 5 to 8 connected to the network 10 requests an image processing list of a server 4. At this time, the digital copying machine transmits model information of its own together with the image processing program list request.

The image processing program list is a list of image processing operations available in the server 4, i.e., a list of image processing programs that the server 4 has. Detailed contents will be described later.

The model information is information necessary for the server 4 for specifying image processing to be coped with by the digital copying machine. Examples of the model information are information representing a color or monochrome copying machine, available resolutions, and number of bits.

Upon receiving the image processing program list request and model information from the digital copying machine, the server 4 generates the image processing program list on the basis of the received model information and image processing program information that the server 4 itself has.

The server 4 stores the frequency of each image processing program executed by the digital copying machine that has sent the image processing program list request. In the image processing program list, the image processing programs are arranged in descending order of frequency, i.e., number or times of use. Hence, the digital copying machine that has received the image processing program list can know image processing often used by the user who is operating the copying machine, and can use the information for the display order on the operation window of the digital copying machine.

The server 4 transmits the generated image processing program list to the digital copying machine as the request source.

Upon receiving the image processing program list, the digital copying machine displays, on the basis of the list, image processing that can be provided to the user.

FIG. 9 is a view showing the operation window of the digital copying machine 5 shown in FIG. 1.

An operation window 100 shown in FIG. 9 corresponds to an input section 56 and display section 57 shown in FIG. 2 and uses a touch panel input scheme so that when the user touches the display portion of an image processing name or the like, the digital copying machine 5 detects it. FIG. 9 shows a window in a server image processing mode in which the user selects one of image processing operations provided by the server 4 connected through the network 10.

On the basis of the image processing program list received from the server 4, the digital copying machine 5 displays the names of image processing operations on the list on the display section 57, i.e., in an image processing name display area 101 of the operation window 100 shown in FIG. 9.

According to the second embodiment, since the digital copying machine 5 displays, for the user, the names of available image processing operations on the basis of the image processing program list generated by the server 4 on the basis of the model information of the digital copying machine 5, the user can be prevented from selecting unavailable image processing, so any confusion in operation can be avoided.

In some cases, all the image processing names cannot be displayed simultaneously on one window because of the space in the image processing name display area 101 of the operation window 100. In this embodiment, a next window button 102 is arranged. When the user touches the next window button 102, the next window is displayed so that the image processing names that cannot be displayed before can be displayed.

The display position of each image processing name in the image processing name display area 101 is preferably determined on the basis of the use frequency of each image processing, which can be known from the image processing program list, as described above. For example, image processing that is most frequently used is displayed on the upper left (OCR in the example shown in FIG. 9). The second image processing often used is displayed on the upper right (mirror image processing in the example shown in FIG. 9). The third image processing often used is displayed on the lower left (halftone dot processing in the example shown in FIG. 9). The fourth image processing often used is displayed on the lower right (synthesis processing in the example shown in FIG. 9) Subsequent processing operations are displayed on the window displayed by operating the next window button 102.

When image processing is selected, specific pages of image data, which are to be subjected to the image processing, can be selected. The example shown in FIG. 9 has an arbitrary button 103 with hatching. This indicates that the arbitrary button 103 is grayed out on the actual operation window 100 and cannot be selected even when the user touches it.

Some image processing operations can be simultaneously executed for the image data. In such a case, the user sequentially selects the image processing operations and then touches an OK button 104 to input an instruction to execute the plurality of image processing operations.

However, some image processing operations cannot be simultaneously executed In this case, the buttons of the unselectable image processing operations are preferably grayed out, like the arbitrary button 103 in FIG. 9, to inhibit the user from selecting them.

As described above, according to the second embodiment, the names of image processing operations often used by the user can be displayed at positions convenient for user operation. Hence, a convenient operation window can be provided.

Since unselectable buttons are grayed out, the user is not confused in operation.

When the user will actually operate the digital copying machine 5 to execute image processing by the server 4, the user operates the operation window 100 to select desired image processing and instruct execution. The digital copying machine 5 transfers information of the image processing contents and image data as an image processing request. Upon receiving the request, the server 4 executes, for the image data, image processing corresponding to the model of the digital copying machine 5 and returns the processed image data to the digital copying machine 5.

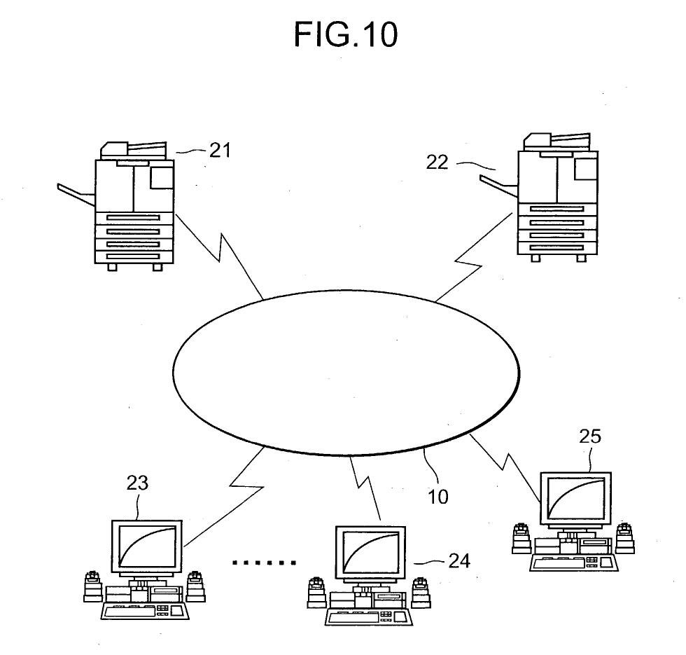

An image forming system according to the third embodiment of the present invention will be described next with reference to FIGS. 10 to 12.

FIG. 10 shows the overall arrangement of an image forming system according to the third embodiment. As shown in FIG. 10, in the image forming system according to the third embodiment, two digital copying machines 21 and 22 and three PCs 23 to 25 are connected through a network 10. The arrangements of each digital copying machine and each PC are the same as those in the first and second embodiments (FIGS. 2 and 4), and a detailed description thereof will be omitted.

In the image forming system according to the third embodiment, one of the PCs 23 to 25 plays a role of a server serving as a relay for image processing distribution. An example in which the PC 23 serves as a server, and the remaining PCs 24 and 25 serve as client PCs that receive an image processing request from the server will be described.

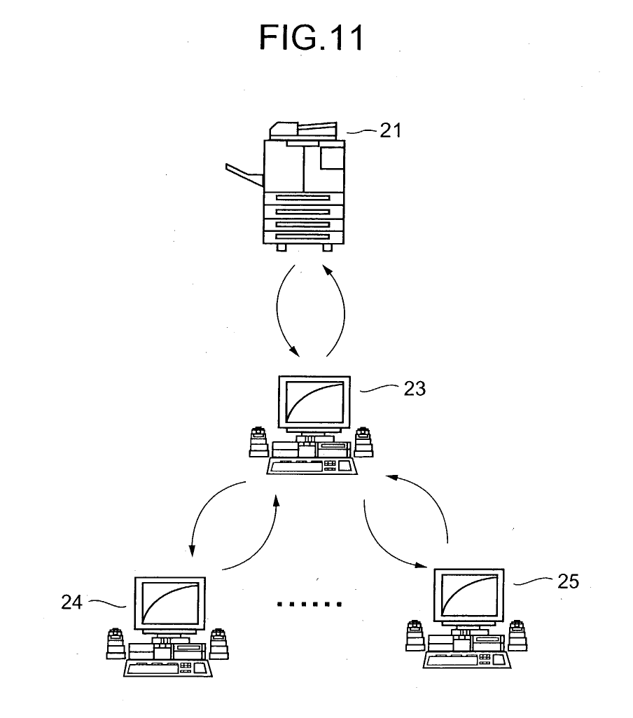

More specifically, in the third embodiment, as shown in FIG. 11, the digital copying machine 21 and PC (server) 23 exchange data, the PC (server) 23 and PC (client PC) 24 exchange data, and the PC (server) 23 and PCs (client PCs) 24 and 25 exchange data.

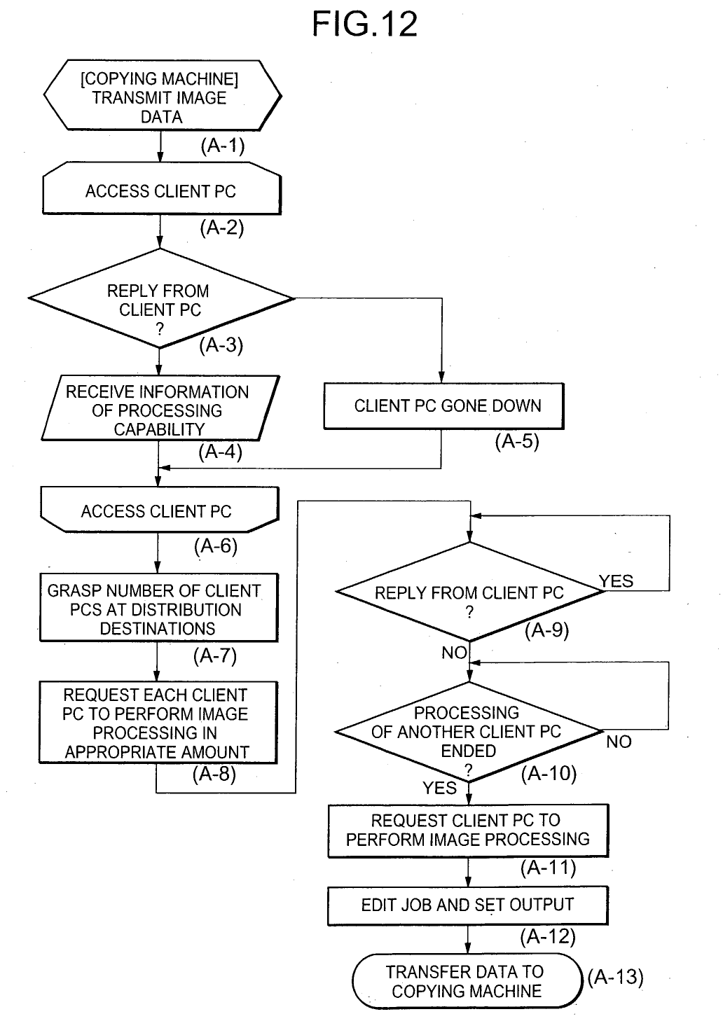

FIG. 12 is a flow chart showing the operation of the image forming system shown in FIG. 10.

When image processing for image data is necessary, the digital copying machine 21 transmits image data and information related to image processing to be executed to the PC 23 that is defined as a server in advance (A-1) Some image processing operations can be executed in the digital copying machine. Such a case may be excluded from this embodiment, i.e., an image processing request from the digital copying machine to the server may be made unnecessary.

In this example, the PC 23 is used as a server. However, any other PC may be used as a server. The PC to be used as a server is preferably selected from PCs registered in the digital copying machine 21 in advance. This is because a scheme of causing the digital copying machine 21 to automatically search for a PC connected to the network 10 and define a server may pose a problem of security.

When the digital copying machine 21 is to transmit image data or the like to the server, it is preferable that information and the like about image processing to be executed be sent first, and then, image data of read pages be sequentially transmitted while reading the image by the image reading section. In this case, since processing for the image data of preceding pages can be executed on the server side while reading the image data, the series of processing operations can be ended in a short time.

Upon receiving the image data and the like from the digital copying machine 21, the PC 23 searches for another PC (client PC) connected to the network 10 and accesses each PC (PCs 24 and 25) (A-2, A-3, A-4, A-5, and A-6).

As a detailed example of this access, first, the PC 23 executes polling (inquiry) to check whether a reply from each client PC is received (A-3).

If YES in step (A-3), the client PC transmits, to the server, the processing capability information (the processing speed of the CPU, a bench mark result measured in advance, the free space of the memory or hard disk, and an available transfer rate for data communication) of the apparatus (client PC). The server receives the processing capability information (A-4).

If NO in step (A-3), the client PC is regarded to be currently in an inoperative state (A-5). The server continues processing for another client PC.

When access to each client PC is ended, the server grasps the number of client PCs that can execute image processing (A-7), distributes the image processing to the client PCs, and requests them to execute image processing in an amount corresponding to their processing capability (A-8). At this time, the server can also be used as a distribution destination and execute image processing corresponding to the processing capability of the server.

In distributing image processing to the client PCs and requesting to execute image processing, the server preferably additionally transmits information representing a specific page of image data of the request or information representing an address (the address of the server on the network, or the like) to which the processed image data should be returned.

A security level may be assigned to each image processing to be distributed, and PCs to which the processing is to be distributed may be limited in accordance with the security level.

Processing in steps (A-7) and (A-8) will be described in more detail.

In the image forming system according to the third embodiment, when image processing requested by the digital copying machine is to be distributed to and processed by the plurality of PCs connected to the network to efficiently end the processing, the processing capability of each PC at the distribution destination is grasped, and control is performed such that the processing times in the respective PCs become uniform.

Hence, in step (A-7), a PC that has transmitted neither reply nor processing capability information in step (A-3) is excluded from PCs to which image processing is to be distributed.

When a PC that has returned a reply cannot sufficiently exhibit its processing capability because it is currently executing another processing, control is preferably performed to transmit a notification representing it to the server. At this time, the server can also exclude the PC from client PCs to which image processing is to be distributed.

Step (A-8) will be described next.

The processing capability of a PC includes the CPU speed, memory capacity, hard disk capacity, and network communication speed, as described above.

An example in which image processing distribution is changed on the basis of the CPU speed will be described first. Assume that three PCs 1, 2, and 3 are used as distribution destination PCs, and their CPU speeds are PC 1: 200 MHz, PC 2: 300 MHz, and PC 3: 500 MHz.

In this case, when a request of image processing for image data of 100 pages is issued, the numbers of pages of image data to be distributed to the PCs are obtained in accordance with equations (1) to (3).

$$\begin{matrix}\begin{matrix}PC1P = ( CPU speed of PC 1 / ( CPU speed of PC 1 + \\ CPU speed of PC 2 + CPU speed of PC 3 ) ) \times \\ total number of pages \\ = ( 200 MHz / ( 200 MHz + 300 MHz + 500 MHz ) ) \times 100 pages\end{matrix} & ( 1 ) \\ \begin{matrix}PC2P = ( CPU speed of PC 2 / ( CPU speed of PC 1 + \\ CPU speed of PC 2 + CPU speed of PC 3 ) ) \times \\ total number of pages \\ = ( 300 MHz / ( 200 MHz + 300 MHz + 500 MHz ) ) \times 100 pages\end{matrix} & ( 2 ) \\ \begin{matrix}PC3P = ( CPU speed of PC 3 / ( CPU speed of PC 1 + \\ CPU speed of PC 2 + CPU speed of PC 3 ) ) \times \\ total number of pages \\ = ( 500 MHz / ( 200 MHz + 300 MHz + 500 MHz ) ) \times 100 pages\end{matrix} & ( 3 )\end{matrix}$$

where PC1P is the number of pages of image data to be distributed to the PC 1, PC2P is the number of pages of image data to be distributed to the PC 2, and PC3P is the number of pages of image data to be distributed to the PC 3.

As a result of equations (1) to (3), if a remainder is left from the number of image data to be distributed, it may be distributed to a PC having the highest CPU speed or a PC which has already ended the distributed processing.

An example in which image processing distribution is changed on the basis of a bench mark result will be described next. Assume that the three PCs 1, 2, and 3 are used as distribution destination PCs, and their bench mark results are PC 1: 2 msec, PC 2: 3 msec, and PC 3: 5 msec.

In this case, when a request of image processing for image data of 100 pages is issued, the numbers of pages of image data to be distributed to the PCs are obtained in accordance with equations (4) to (6).

$$\begin{matrix}\begin{matrix}{PC1P}^{′} = ( reciprocal of bench mark result of PC 1 / \\ ( reciprocal of bench mark result of PC 1 + \\ reciprocal of bench mark result of PC 2 + \\ reciprocal of bench mark result of PC 3 ) ) \times \\ total number of pages \\ = ( 1 / 2 msec / ( 1 / 2 msec + 1 / 3 msec + 1 / 5 msec ) ) \times 100 pages\end{matrix} & ( 4 ) \\ \begin{matrix}{PC2P}^{′} = ( reciprocal of bench mark result of PC 2 / \\ ( reciprocal of bench mark result of PC 1 + \\ reciprocal of bench mark result of PC 2 + \\ reciprocal of bench mark result of PC 3 ) ) \times \\ total number of pages \\ = ( 1 / 3 msec / ( 1 / 2 msec + 1 / 3 msec + 1 / 5 msec ) ) \times 100 pages\end{matrix} & ( 5 ) \\ \begin{matrix}{PC3P}^{′} = ( reciprocal of bench mark result of PC 3 / \\ ( reciprocal of bench mark result of PC 1 + \\ reciprocal of bench mark result of PC 2 + \\ reciprocal of bench mark result of PC 3 ) ) \times \\ total number of pages \\ = ( 1 / 5 msec / ( 1 / 2 msec + 1 / 3 msec + 1 / 5 msec ) ) \times 100 pages\end{matrix} & ( 6 )\end{matrix}$$

where PC1P′ is the number of pages of image data to be distributed to the PC 1, PC2P′ is the number of pages of image data to be distributed to the PC 2, and PC3P′ is the number of pages of image data to be distributed to the PC 3.

As a result of equations (4) to (6), if a remainder is left from the number of image data to be distributed, it may be distributed to a PC having the highest bench mark result or a PC which has already ended the distributed processing.

Subsequent to step (A-8), the server inspects at a predetermined interval whether each of the client PCs to which image processing is distributed to request processing has gone down.

More specifically, a reply from each client PC is confirmed (A-9). If no reply is received from a client PC, image processing assigned to the client PC is re-distributed to another client PC that is normally operating (A-10 and A-11).

Each client PC that has ended the processing returns the processed image data to the server. When the distributed image processing is completely ended, and all processed image data are received, the server executes post-processing for image output by rearranging the image data in the order of pages, editing the job, and setting the output time (A-12) and transfers the data to the digital copying machine 21 (A-13).

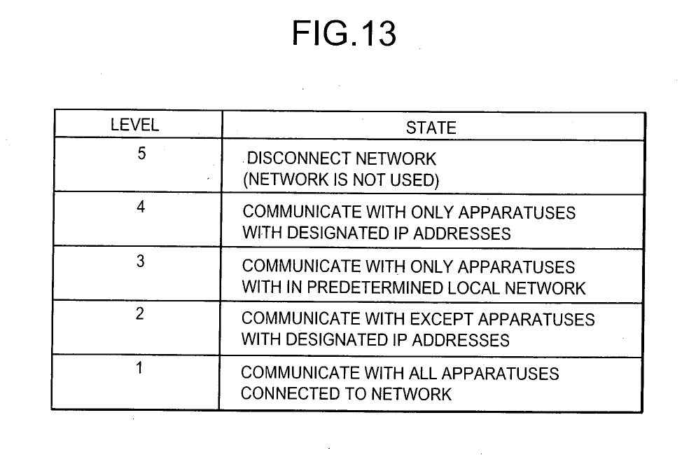

The fourth embodiment of the present invention will be described next with reference to FIGS. 1 and 13.

The overall arrangement of the image forming system according to the fourth embodiment is the same as that of the first embodiment shown in FIG. 1. The digital copying machines, server, and PCs used in the image forming system are also the same as those of the first embodiment (FIGS. 2 to 4), and a detailed description thereof will be omitted.

In the image forming system according to the fourth embodiment, a server 4 connected to a network manages security level.

Security level is defined for, e.g., each user in advance. When a user inputs an image processing instruction in a digital copying machine 5, authentication based on, e.g., a password is executed first to define a communicable network range in accordance with the security level set for the user in advance.

FIG. 13 is a table showing an example of security level.

FIG. 13 shows an example in which five grades of security level are set. The number of grades of security level is not limited to five, and any other number of grades may be set, as a matter of course.

Security level 1 indicates the highest use authority. A user who is set to this level can communicate with all apparatuses connected to the network, i.e., use image processing provided by any one of all the apparatuses connected to the network.

At security level 2, communication can be executed with only apparatuses except those having IP addresses designated in advance. A user who is set to this level can use image processing provided by any one of the communicable apparatuses.

At security level 3, communication can be executed with only apparatuses in a predetermined local network. A user who is set to this level can use image processing provided by any one of the communicable apparatuses. In this case, if a local network is constructed in the user's company and also connected to an external network, communication can be performed with only apparatuses connected to the intraoffice network.

At security level 4, communication can be executed with only apparatuses having IP addresses designated in advance. A user who is set to this level can use image processing provided by any one of the communicable apparatuses.

At security level 5, communication cannot be executed with any one of the apparatuses connected to the network. A user who is set to this level can use only image processing provided by a digital copying machine 5 used by him/her.

In the server 4, a user ID that specifies a user and a password for authentication and security level, which correspond to the user ID, are stored in a storage section 43 (FIG. 3) When the user inputs the user ID from an input section 56 (FIG. 2) of the digital copying machine 5 to start operation, the user is authenticated with reference to the password stored in the storage section 43 and permitted to execute operation at the security level set for him/her.

Only a specific administrator user is preferably permitted to set or change security level for each user such that illicit network processing can be suppressed.

When security level is set for each user, as described above, available image processing changes between users. When the names of, e.g., available image processing operations are displayed on a universal operation section 17 of the digital copying machine 5, the display contents are changed for each user. The names of image processing operations unusable for a user may be grayed out or hatched in an inoperable state or completely turned off.

Alternatively, each user may input a choice from the input section 56 of the digital copying machine 5 to indicate whether he/she is to be connected to the network.

On the basis of this input, the server 4 may define whether the network can be used in the allowable range of security level or not be used.

Instead, the current security level may be displayed on a display section 57 (FIG. 2) of the digital copying machine 5 such that the user can know the security level and operate without anxiety.

In the fourth embodiment, the security level is set for each user. However, the present invention is not limited to this. For example, the security level may be changed or set for every opportunity of image processing.

The server 4 preferably records the log (history) of processing executed through the network of the entire image forming system. In this case, the network administrator can grasp the time and user of each function.

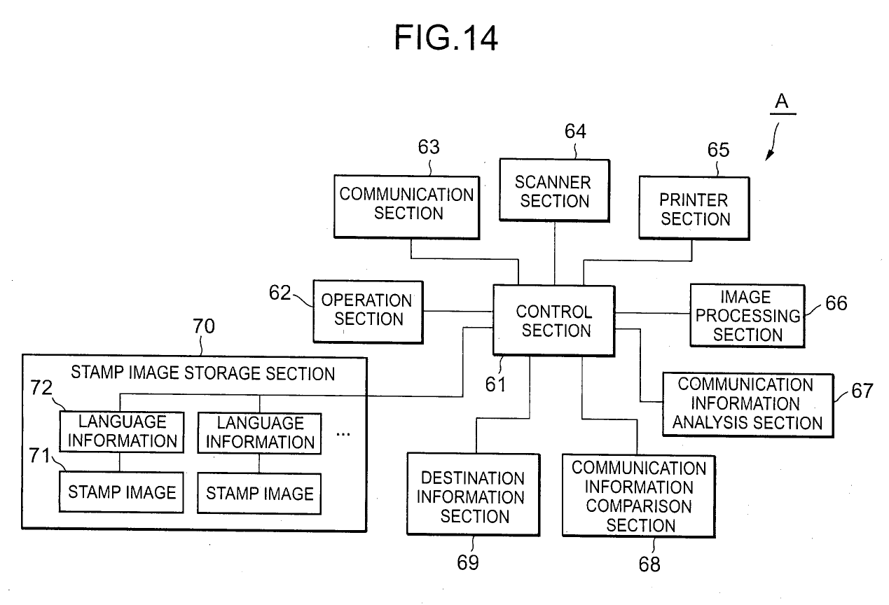

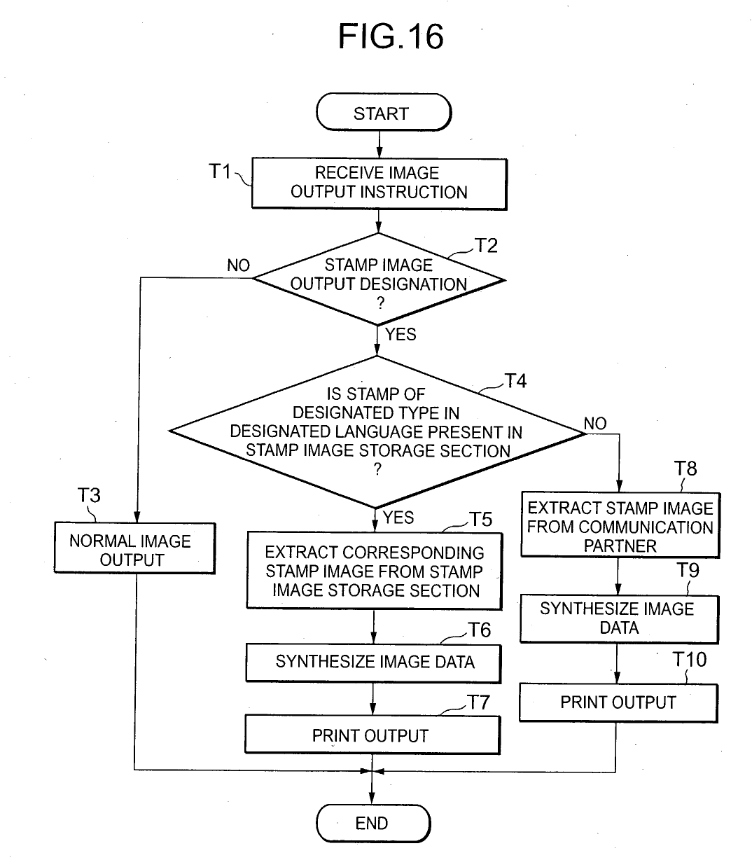

An embodiment of a stamp function using a digital copying machine in each embodiment of the image forming system according to the present invention will be described next with reference to FIGS. 14 to 16.

A digital copying machine A used in the image system of the present invention has components shown in FIG. 14. As shown in FIG. 14, the digital copying machine is constituted by a control section 61, operation section 62, communication section 63, scanner section 64, printer section 65, image processing section 66, communication information analysis section 67, destination information comparison section 68, destination information section 69, and stamp image storage section 70. The digital copying machine will simply be referred to as a copying machine hereinafter.

The control section 61 performs various kinds of control operations in accordance with a control program for the copying machine A, which is stored in a ROM (Read Only Memory) (not shown).

The operation section 62 has various operation keys for inputting settings or operation instructions for the copying machine A and outputs press signals of the operation keys to the control section 61. The operation section 62 also has an operation panel (touch panel) having a function as a display section (not shown). The operation panel covers a display section formed from an LCD (Liquid Crystal Display) or the like, detects coordinates touch-indicated by a coordinate reading principle such as an electromagnetic induction, magnetic strain, or pressure-sensitive scheme, and outputs the detected coordinates to the control section 61 as a position signal. The operation panel serving as a display section performs predetermined display in accordance with a display control signal input from the control section 61.

The communication section 63 transmits/receives an operation command or image information to/from another copying machine (not shown) through the network.

The scanner section 64 is formed from a light source, CCD (Charged Coupled Device), A/D converter, and the like. The scanner section 64 irradiates an original placed on the original table of the copying machine A with light, converts reflected light into an electrical signal (analog signal) by the CCD, and converts the analog signal into digital data by the A/D converter.

The printer section 65 prints and outputs an image that is instructed by the control section 61 to print the image on a recording paper sheet by a printing scheme such as electrophotography or inkjet.

The image processing section 66 executes image synthesis to insert a stamp image to image data read by the scanner section 64.

The communication information analysis section 67 analyzes data obtained by communication with another copying machine through the communication section 63. More specifically, the communication information analysis section 67 analyzes data received from a copying machine serving as a stamp image output destination and determines, on the basis of the analysis result, the presence/absence of the stamp function of the output destination copying machine.

The destination information comparison section 68 compares destination information of the copying machine, which is stored in the destination information section 69, with destination information of another copying machine, which is acquired by communication through the communication section 63.

The destination information section 69 stores, as destination information of the copying machine, the language in the area (destination area) where the copying machine is installed, power supply specification, zoom specification, copy count scheme, and the like.

The stamp image storage section 70 stores a stamp image 71 of at least one language and language information 72 of the stamp image in correspondence with each other.

The operation of the stamp function of the present invention will be described next with reference to FIGS. 15-1 to 16.

Processing of causing the copying machine A applied to the image forming system according to the present invention (connected through the network) to transmit a stamp image output instruction to another copying machine B (not shown) will be described first with reference the flow charts shown in FIGS. 15-1 to 15-3. In the following description, the copying machines A and B have different destination languages (for example, the copying machine A has a Japanese specification, and the copying machine B has an English specification).

When the stamp function is selected from the operation section 62 (step S1), stamp image information stored in the stamp image storage section 70 is displayed on the operation panel of the operation section 62 (step S2).

When the operator of the copying machine A operates the operation panel to select, from the stamp image information displayed on the operation panel, a stamp image to be output (step S3), the window of the operation panel changes to a copying machine selection window to display a list of copying machines as stamp image output destination candidates (step S4).

From the copying machine list displayed on the operation panel, a copying machine to which the stamp image should be output is selected by operation on the operation panel (step S5). Assume that the copying machine B is selected as a stamp image output destination. The output destination copying machine is selected here after selection of the stamp function. However, the order of these operations may reverse.

If the copying machine list displayed on the operation panel in step S4 does not include the output destination copying machine, the operator newly inputs information about the corresponding copying machine from the operation section 62 to add the copying machine to the copying machine list. Instead of inputting copying machines to be listed from the operation section 62, a command to check the current connection state may be transmitted from the communication section 63 on the basis of net mask information and IP address, which are set for each copying machine, and copying machines that have returned replies for the command may be displayed.

When the copying machine B as a stamp image output destination is selected in step S5, communication is started through the communication section 63 to confirm the state of the copying machine B connected to the network 10 (step S6). In the communication in step S6, a reply code, options, and the like returned from the copying machine B. The options include the types of stamp images stored in the copying machine B and language information.

If no reply code is returned from the copying machine B even after the elapse of a predetermined time from the start of communication in step S6, and communication with the copying machine B is impossible due to some reason (NO in step S7), a timeout error is displayed on the operation panel, and the processing is ended.

When the reply code and options are returned to the copying machine A, and communication with the copying machine B is possible (YES in step S7), the communication information analysis section 67 analyzes the data of the options (step S8). It is determined on the basis of the analysis result whether the copying machine B has the stamp function (step S9).

If it is determined as a result of option data analysis in step S8 that the copying machine B has the stamp function (YES in step S9), the destination information comparison section 68 compares the destination information of the copying machine A, which is stored in the destination information section 69, with the destination information of the copying machine B, which is acquired by communication with the copying machine B (step S10).

Next, “output in destination language of copying machine A or output in destination language of copying machine B” is displayed on the operation panel to select the use language for the stamp image. The destination language of the copying machine A or that of the copying machine B is selected by operation on the operation panel (step S11).

If “output in destination language of copying machine A” is selected in language selection in step S11 (YES in step S12), the communication information analysis section 67 analyzes data about the copying machine B, which is obtained by communication in step S6, to determine whether the copying machine B has the stamp of the destination language of the copying machine A (step S13).

If it is determined in step S13 that the copying machine B has the stamp of the destination language of the copying machine A (YES in step S13), the original placed on the original table is read by the scanner section 64. The read original image (scanner image) and stamp information (type of stamp, language, and output position information) are transmitted to the copying machine B through the communication section 63 (step S14) Then, the processing is ended.

If it is determined in step S13 that the copying machine B has no stamp of the destination language of the copying machine A (NO in step S13), the original placed on the original table is read by the scanner section 64. The read original image (scanner image), stamp information, and the image data of a stamp in the destination language of the copying machine A are transmitted to the copying machine B through the communication section 63 (step S15). Then, the processing is ended.

Referring back to step S12, if “output in destination language of copying machine B” is selected in language selection in step S11 (NO in step S12), the communication information analysis section 67 analyzes data about the copying machine B, which is obtained by communication in step S6, to determine whether the copying machine B has a stamp of same type as the stamp selected in step S3 (step S16).

If it is determined in step S16 that the copying machine B has a stamp of same type (YES in step S16), the original, placed on the original table is read by the scanner section 64. The read original image (scanner image) and stamp information are transmitted to the copying machine B through the communication section 63 (step S17). Then, the processing is ended.

If it is determined in step S16 that the copying machine B has no stamp of same type (NO in step S16), a stamp of that type in the destination language of the copying machine B is searched for from the stamp image storage section 70. If the copying machine A has a stamp of that type in the destination language of the copying machine B (YES in step S18), the stamp is extracted from the stamp image storage section 70. The original image (scanner image) read by the scanner section 64, stamp information, and the image data of the extracted stamp are transmitted to the copying machine B through the communication section 63 (step S19). Then, the processing is ended.

If a stamp of the type in the destination language of the copying machine B is searched for from the stamp image storage section 70, and the copying machine A has no stamp of that type in the destination language of the copying machine B (NO in step S18), the control section 61 determines whether the copying machine A is connected to the Internet through the communication section 63 (step S20).

If it is determined in step S20 that the copying machine A is connected to the Internet (YES in step S20), a stamp of that type in the destination language of the copying machine B is searched for on the Internet through the communication section 63.

If the data of the stamp image is detected on the Internet as a result of search there (YES in step S21) the stamp image data is acquired. The original image (scanner image) read by the scanner section 64, stamp information, and the acquired stamp image data are transmitted to the copying machine B through the communication section 63 (step S22). Then, the processing is ended.

If it is determined in step S20 that the copying machine A is not connected to the Internet (NO in step S20), “no stamp image” is displayed on the operation panel (step S23). Then, the processing is ended.

When the copying machine A is connected to the Internet, and no stamp image data is present on the Internet (NO in step S21), the flow advances to step S23 to display “no stamp image” on the operation panel. Then, the processing is ended.

Referring back to step S9, if it is determined as a result of option data analysis in step S8 that the copying machine B has no stamp function (NO in step S9), “copying machine B has no stamp function” is displayed on the operation panel (step S30). Then, the destination information comparison section 68 compares the destination information of the copying machine A, which is stored in the destination information section 69, with the destination information of the copying machine B, which is acquired by communication with the copying machine B (step S31).

Next, “output in destination language of copying machine A, output in destination language of copying machine B, or cancel output” is displayed on the operation panel to select the use language for the stamp image. One of the above three options is selected by operation on the operation panel (step S32). If “cancel output” is selected in language selection in step S32 (YES in step S33), the control section 61 stops the series of operations for stamp image output. Then, the processing is ended.

If “output in destination language of copying machine A” is selected in language selection in step S32 (YES in step S34), the original is read by the scanner section 64, and stamp image data in the destination language of the copying machine A is extracted from the stamp image storage section 70 (step S35). The image processing section 66 inserts the stamp image data extracted from the stamp image storage section 70 into the image data (scan image) read by the scanner section 64 (step S36). The image data with the stamp image inserted is transmitted to the copying machine B through the communication section 63 (step S37). Then, the processing is ended.

If “output in destination language of copying machine B” is selected in language selection in step S32 (NO in step S34), a stamp of same type as the stamp selected in step S3, which has the destination language of the copying machine B, is searched for from the stamp image storage section 70 (step S38).

If, in step S38, a stamp of same type in the destination language of the copying machine B is present in the stamp image storage section 70 (YES in step S38), the corresponding stamp image is extracted from the stamp image storage section 70 (step S39). The image processing section 66 inserts the stamp image data extracted from the stamp image storage section 70 into the image data (scanner image) read by the scanner section 64 (step S40). The image data with the stamp image inserted is transmitted to the copying machine B through the communication section 63 (step S41). Then, the processing is ended.

If a stamp of the type in the destination language of the copying machine B is not present in the stamp image storage section 70 (NO in step S38), the control section 61 determines whether the copying machine A is connected to the Internet through the communication section 63 (step S42).

If it is determined in step S42 that the copying machine A is connected to the Internet (YES in step S42), a stamp of that type in the destination language of the copying machine B is searched for on the Internet through the communication section 63.

If the data of the stamp image is detected on the Internet as a result of search there (YES in step S43), the stamp image data is acquired. The image processing section 66 inserts the stamp image data acquired from the Internet to the original image (scanner image) read by the scanner section 64 (step S44). The image data with the stamp image inserted is transmitted to the copying machine B through the communication section 63 (step S45). Then, the processing is ended.

If it is determined in step S42 that the copying machine A is not connected to the Internet (NO in step S42), “no stamp image” is displayed on the operation panel (step S46). Then, the processing is ended.

When the copying machine A is connected to the Internet, and no stamp image data is present on the Internet (NO in step S43), the flow advances to step S46 to display “no stamp image” on the operation panel. Then, the processing is ended.

The operation on the side (receiving side) of the copying machine B which receives the image output instruction from the copying machine A will be described next. The copying machine B has a stamp function and the same arrangement as that of the copying machine A shown in FIG. 14.

When the image output instruction is received through the communication section in communication with the copying machine A (step T1), the control section of the copying machine B determines first the presence/absence of a stamp output designation in the received image output instruction (step T2). If it is determined in step T2 that no stamp output designation is present (NO in step T2), the printer section executes normal image output on the basis of the image output instruction received from the copying machine A (step T3). Then, the processing is ended.

If it is determined in step T2 that a stamp output designation is present (YES in step T2), the language of the stamp and the type of the stamp are extracted from stamp information transmitted from the copying machine A. A stamp image of the type in the language designated by the stamp information is searched for from the stamp image storage section.

When the stamp image storage section has the designated stamp image (YES in step T4), the stamp image is extracted from the stamp image storage section (step T5). The image processing section synthesizes the image data (scanner image) of the read original transmitted from the copying machine A with the stamp image data extracted from the stamp image storage section in step T5 (step T6). The printer section prints and outputs the synthesized image data (step T7). Then, the processing is ended.

If the stamp image storage section does not have the designated stamp image (NO in step T4), the stamp image transmitted from the copying machine A is extracted (step T8). The image processing section synthesizes the data of the stamp image extracted in step T8 to a position designated by the stamp information on the image of the read original (scanner image) transmitted from the copying machine A (step T9). The printer section prints and outputs the synthesized image data (step T10). Then, the processing is ended.

As described above, according to the copying machine A of this embodiment, the stamp image output form is selected on the basis of the destination information of the copying machine at the connection destination or the presence/absence of the stamp function, and the stamp image is output to the copying machine. Hence, appropriate stamp image output can be performed by various kinds of copying machines.

Especially, when the copying machine at the connection destination has no stamp function, a stamp image is inserted to the read original, and image data with the stamp image inserted is transmitted. With this processing, even the copying machine having no stamp function can output the stamp image.

In addition, even when the source copying machine and the connection destination copying machine have different destination languages, a stamp image in the destination language of the connection destination copying machine can be output by acquiring a stamp in the destination language of the connection destination copying machine from the stamp image storage section 70 or Internet.

Whether a stamp image should be output in the destination language of the source copying machine or in the destination language of the connection destination copying machine can be selected by the operator's discretion. Hence, the convenience of stamp image output can be increased. For example, when it is determined that the contents of the stamp image are not understandable in the destination language of the source copying machine, output in the destination language of the connection destination copying machine is selected to output an appropriate stamp image.

When the connection destination copying machine has a stamp image of the same type as that of the stamp image of the source copying machine, the stamp image itself need not be transmitted. Hence, the image output efficiency can be increased.

When the connection destination copying machine has no stamp function, stamp image output can be stopped Hence, any operation error at the connection destination copying machine can be prevented.

The contents described in the embodiment are not limited to the above contents, and various changes and modifications can appropriately be made within the spirit and scope of the invention.

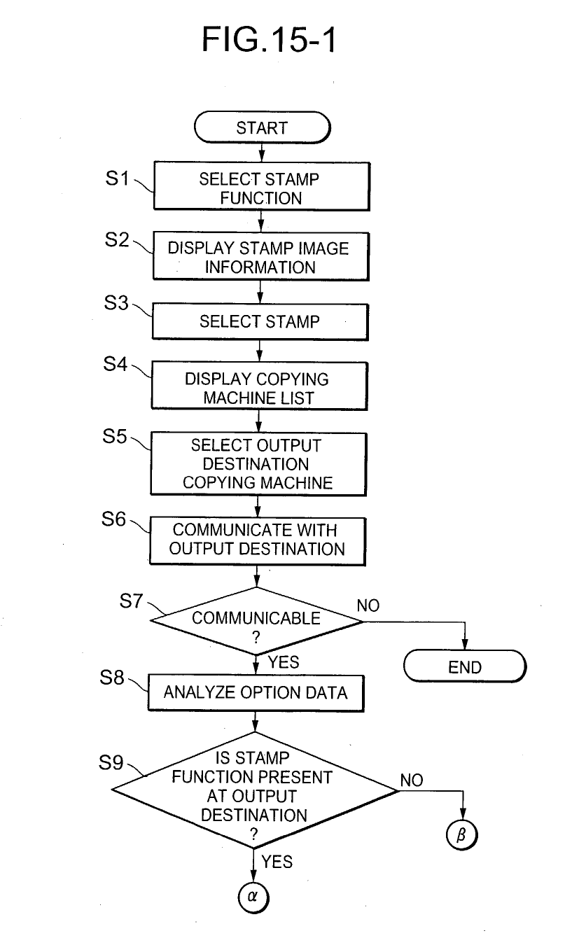

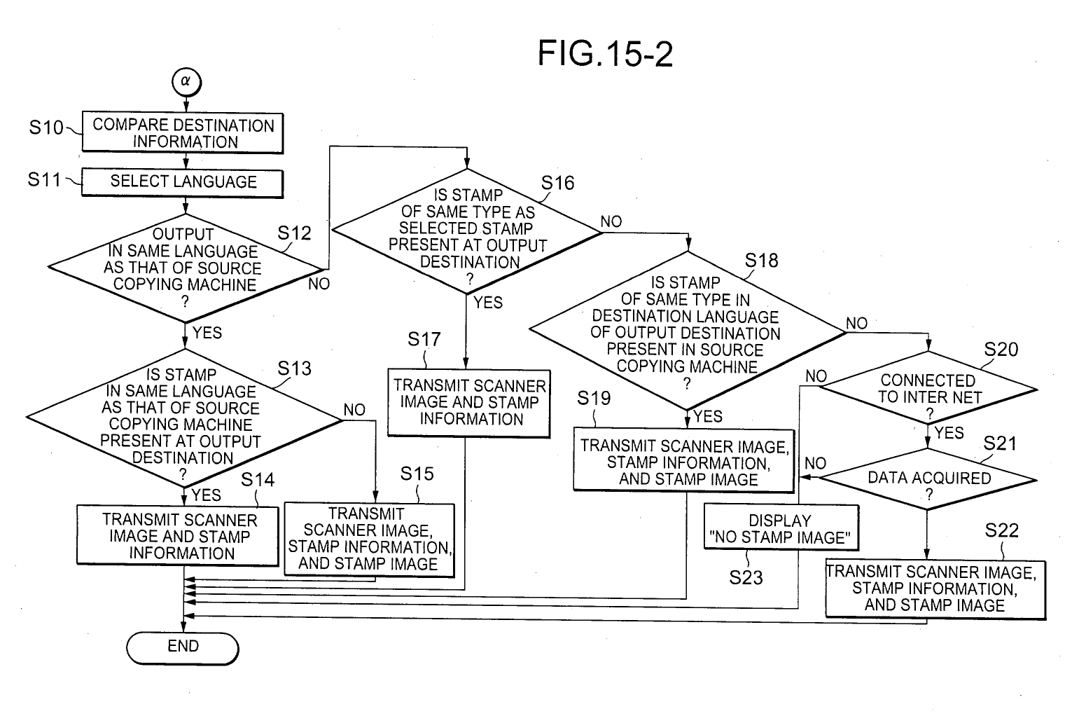

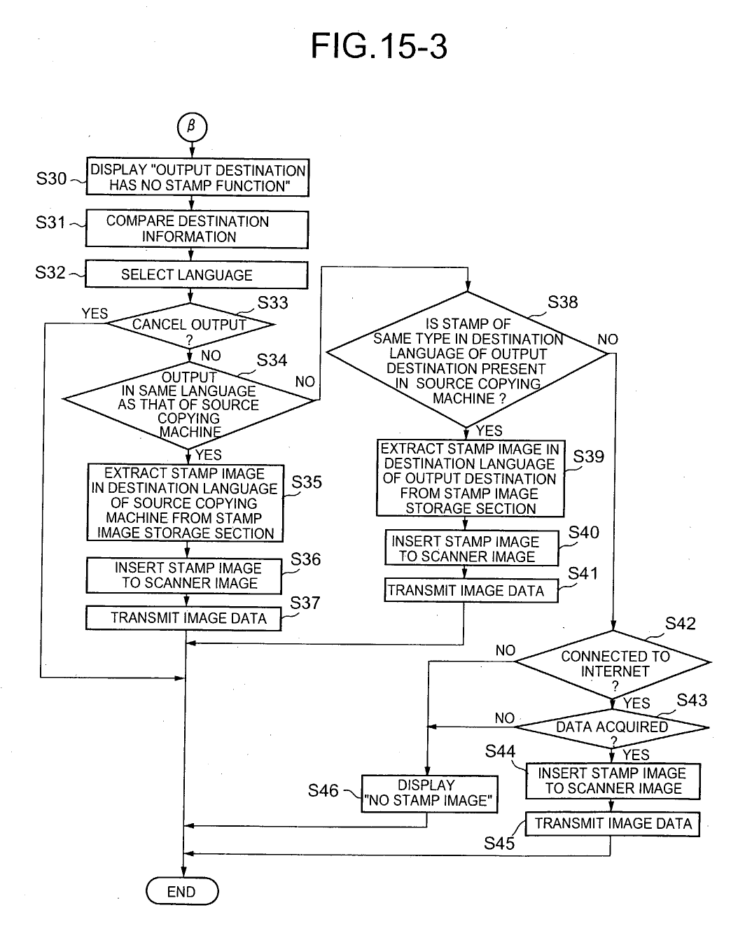

For example, in the embodiment, whether the stamp image to be output to the copying machine B should be output in the destination language of the source copying machine or that of the copying machine B at the connection destination is selected by the operator of the source copying machine. However, pre-setting may be done to automatically output the stamp image in the destination language of the connection destination copying machine. Similarly, pre-setting may be done to automatically output the stamp image in the same language as that used by the stamp image selected in step S3 in FIG. 15-1.

In the embodiment, if the copying machine B has no stamp function, the operator of the source copying machine designates execution or stop of stamp image output. However, pre-setting may be done to automatically stop stamp image output to a copying machine having no stamp function under the control of the control section 61.

What is claimed is:

1. An image forming system in which at least one or a plurality of information processing apparatuses which execute image processing for image data and at least one or a plurality of image forming apparatuses which form an image on a transfer material (paper sheet) on the basis of the image data that has undergone the desired image processing are connected to each other through a network, wherein
a first information processing apparatus comprises
model information inquiry means for inquiring about model information of each apparatus connected to the network,
image processing means for executing, for the image data, image processing based on the model information, and
data distribution means for distributing job data based on the model information and the processed image data that has undergone the image processing on the basis of the model information to each of said apparatuses connected to each other through the network, and
each of said image forming apparatuses comprises
first data reception means for receiving the job data based on the processed image data and model information from said data distribution means, and
image forming means for forming the image on the transfer material on the basis of the processed image data.

2. A system according to claim 1, wherein the image processing executed by said image processing means on the basis of the model information is processing of changing a data format of the image data.

3. A system according to claim 1, wherein the image processing executed by said image processing means on the basis of the model information is processing of changing a resolution or number of gray levels of the image data.

4. A system according to claim 1, wherein the image processing executed by said image processing means on the basis of the model information is processing of converting color image data into monochrome image data and vice versa.

5. A system according to claim 1, wherein
said first information processing apparatus further comprises distribution destination designation means for allowing a user to designate a designation of distribution of the processed image data by said data distribution means, said distribution destination designation means having group forming means for putting other apparatuses connected to the network into a group, and
when the user is to designate the distribution destination, the apparatuses put into the group by said group forming means can be designated at a time.

6. A system according to claim 1, wherein when said data distribution means is to distribute the image data to said plurality of image forming apparatuses which execute tandem output, a data amount to be allotted to each of said plurality of image forming apparatuses which execute tandem output is determined on the basis of the model information.

7. A system according to claim 1, wherein each image forming apparatus further comprises banner image forming means for forming a banner image representing a processing result of image formation when said image forming means is to form the image on the basis of the processed image data received by said first data reception means.

8. A system according to claim 7, wherein the banner image formed by said banner image forming means represents information about a distribution source of the image data.

9. A system according to claim 1, wherein said first information processing apparatus further comprises transmission destination specifying information transmission means for transmitting, to an apparatus at a distribution destination, transmission destination specifying information formed from a predetermined character or symbol corresponding to an address of the apparatus at the transmission destination when said data distribution means is to distribute the processed image data.

10. A system according to claim 1, wherein said data distribution means distributes the processed image data and job data to each of said apparatuses connected to each other through the network at a predetermined designated time.

11. A system according to claim 1, wherein
each of said image forming apparatuses further comprises
image data transmission means for transmitting information about desired image processing to be executed for the image data to said first information processing apparatus together with the image data,
list request transmission means for transmitting model information of said image forming apparatus to said first information processing apparatus together with a request of an image processing program list, and
list display means for displaying a list of executable image processing programs on the basis of the image processing program list received from said information processing apparatus as a reply to the request transmitted by said list request transmission means, and
said first information processing apparatus further comprises
list generation means for generating the image processing program list on the basis of the model information received from each of said image forming apparatuses, and
list transmission means for transmitting the image processing program list generated by said list generation means to said image forming apparatus that has requested the image processing program list.

12. A system according to claim 11, wherein
said processed image data transmission means comprises image processing use frequency recording means for recording a use frequency of image processing of each type requested for the image data received from said image forming apparatus,
said list generation means generates the program list on the basis of the use frequency recorded by said image processing use frequency recording means, and
said list display means determines an order of display of image processing operations in the list of the executable image processing programs on the basis of the program list generated on the basis of the use frequency.

13. A system according to claim 1, further comprising a universal apparatus which is connected to said image forming apparatuses and information processing apparatuses through the network and has a universal display section, a universal operation section, and remote setting means for executing setting related to image processing and job processing on the basis of the model information of said image forming apparatuses and information processing apparatuses.
